(19) United States
(12) Patent Application Publication
(10) Pub. No.: US 2026/0280185 A1
(43) Pub. Date: Sep. 17, 2026

(54) CONNECTOR

(71) Applicant: Japan Aviation Electronics Industry, Limited, Tokyo (JP)

(72) Inventor: Kenta ASHIBU, Tokyo (JP)

(21) Appl. No.: 19/537,971

(22) Filed: Feb. 12, 2026

(30) Foreign Application Priority Data
Mar. 17, 2025 (JP) 2025-042014

(51) Int. Cl. H01R 13/627

(52) U.S. Cl. CPC H01R 13/6272

(57) ABSTRACT

A connector includes a housing having a counter connector accommodating portion, a slider disposed on the housing so as to be slidable along a fitting direction, and an elastic member for pushing the slider forward along the fitting direction, the slider including a slider body having a cam groove, a slide arm elastically deformable in a first direction orthogonal to the fitting direction, the housing including a lock arm exposed to the counter connector accommodating portion and elastically deformable in the second direction, a cam projection projecting in the first direction from a side surface of the lock arm, and a slide arm deforming portion which makes contact with the slide arm of the slider retracted in the fitting direction to elastically deform the slide arm in the first direction.

### BACKGROUND OF THE INVENTION

The present invention relates to a connector, particularly to a connector having a lock mechanism that locks a fitting state between the connector with a counter connector.

As the connector having such a lock mechanism, JP 6265383 B2 discloses a connector 4 which includes a housing 1 and a slider 2 and in which the slider 2 is attached to the housing 1 so as to be elastically pressed toward a counter connector with a pair of compression springs 3 as shown in FIG. 39.

As shown in FIG. 40, when a counter connector 5 is relatively moved toward the connector 4, a slider arm 2A of the slider 2 is pressed by a projection 5A of the counter connector 5 and retracted, a lock arm 1A of the housing 1 makes contact with a guide portion 2B of the slider 2 and is deformed, a locking portion 1B is lifted up and passes above of a locking portion 5B of the counter connector 5, and the slider arm 2A is upwardly deformed, whereby contact between the slider arm 2A and the projection 5A of the counter connector 5 is released. As a result, the slider 2 advances due to the action of the compressing springs 3, the deformation of the lock arm 1A is released, the locking portion 1B of the housing 1 catches on the locking portion 5B of the counter connector 5, and thus, the fitting state between the connector 4 and the counter connector 5 is locked.

When the fitting state between the connector 4 and the counter connector 5 is released, it suffices if an operating portion 2C of the slider 2 is slid rearward with respect to the housing 1 against the elastic force of the compressing springs 3, the lock arm 1A is upwardly deformed to release the interlock between the locking portion 1B and the locking portion 5B, and the counter connector 5 is pulled out from the connector 4.

However, as shown in FIG. 40, the operating portion 2C of the slider 2 is exposed on an upper portion of the housing 1 on the rear side thereof and is disposed at a position where the operator grasps the connector 4 when the connector 4 is fitted to the counter connector 5.

Therefore, the operator's finger easily makes contact with the slider 2, which may cause a problem on a desired operation of the slider 2 with respect to the housing 1.

Thus, in the connector of JP 6265383 B2, there is a problem in that the operability at the time of fitting is inferior.

### SUMMARY OF THE INVENTION

The present invention has been made to overcome the above problem associated with the prior art and aims at providing a connector that can improve the operability at the time of fitting while the connector includes a lock mechanism that locks the fitting state between the connector and a counter connector.

A connector according to the present invention comprises:
a housing having a counter connector accommodating portion;
a slider disposed on the housing so as to be slidable along a fitting direction; and
an elastic member for pushing the slider forward along the fitting direction,
wherein the slider includes:
   a slider body in which a cam groove extending in the fitting direction is formed;
   a slide arm which extends in the fitting direction and is elastically deformable in a first direction orthogonal to the fitting direction; and
   an operating portion that is disposed on the slider body and exposed from the housing to project in a second direction orthogonal to both the fitting direction and the first direction,
the housing includes:
   a lock arm which extends along the fitting direction, is exposed to the counter connector accommodating portion, and is elastically deformable in the second direction;
   a cam projection which is formed to project in the first direction from a side surface of the lock arm and is inserted into the cam groove; and
   a slide arm deforming portion which makes contact with the slide arm of the slider retracted in the fitting direction so that the slide arm is elastically deformed in the first direction,
when the counter connector is inserted into the counter connector accommodating portion, the counter connector abuts a front end portion of the slide arm to make the slider retracted from an initial position along the fitting direction,
the lock arm is elastically deformed in the second direction along with insertion of the counter connector into the counter connector accommodating portion,
when the slide arm makes contact with the slide arm deforming portion and is elastically deformed in the first direction, a contact between the slide arm and the counter connector is released, and the slider is returned to the initial position due to the elastic member,
the lock arm is elastically restored so that a fitting state of the connector with the counter connector is locked by a locking portion formed in the lock arm, and
when the slider is retracted from the initial position along the fitting direction by the operating portion, the cam projection is relatively moved along the cam groove so that the lock arm is elastically deformed in the second direction, and a locking of the fitting state of the connector with the counter connector is released.

### BRIEF DESCRIPTION OF THE DRAWINGS

FIG. 1 is a perspective view showing a connector according to an embodiment.

FIG. 2 is a perspective view showing a housing of the connector.

FIG. 3 is a front view showing the housing of the connector.

FIG. 4 is a plan view showing the housing of the connector.

FIG. 5 is a cross-sectional view taken along line A-A in FIG. 3.

FIG. 6 is a cross-sectional view taken along line B-B in FIG. 3.

FIG. 7 is a back view showing the housing of the connector.

FIG. 8 is a perspective view showing a slider of the connector.

FIG. 9 is a plan view showing the slider of the connector.

FIG. 10 is a side view showing the slider of the connector.

FIG. 11 is a front view showing the slider of the connector.

FIG. 12 is a back view showing the slider of the connector.

FIG. 13 is a bottom view showing the slider of the connector.

FIG. 14 is an enlarged partial view of FIG. 12.

FIG. 15 is a cross-sectional view taken along line C-C in FIG. 9.

FIG. 16 is a front view showing the connector of the embodiment.

FIG. 17 is a back view showing the connector of the embodiment.

FIG. 18 is a plan view showing the connector of the embodiment.

FIG. 19 is an enlarged partial view of FIG. 16.

FIG. 20 is a cross-sectional view taken along line D-D in FIG. 16.

FIG. 21 is a cross-sectional view taken along line E-E in FIG. 16.

FIG. 22 is a cross-sectional view taken along line F-F in FIG. 18.

FIG. 23 is a cross-sectional view taken along line G-G in FIG. 17.

FIG. 24 is an enlarged partial view of FIG. 22.

FIG. 25 is a side view showing a counter connector.

FIG. 26 is a front view showing the counter connector.

FIG. 27 is a cross-sectional view showing the connector in a state where the counter connector starts to be inserted into a counter connector accommodating portion in connection with FIG. 20.

FIG. 28 is a cross-sectional view showing the connector in the state where the counter connector starts to be inserted into the counter connector accommodating portion in connection with FIG. 21.

FIG. 29 is a cross-sectional view showing the connector in the state where the counter connector starts to be inserted into the counter connector accommodating portion in connection with FIG. 23.

FIG. 30 is a cross-sectional view showing the connector in the process of fitting with the counter connector in connection with FIG. 20.

FIG. 31 is a cross-sectional view showing the connector in the process of fitting with the counter connector in connection with FIG. 21.

FIG. 32 is a cross-sectional view showing the connector in the process of fitting with the counter connector in connection with FIG. 23.

FIG. 33 is a cross-sectional view showing the connector immediately before completion of fitting with the counter connector in connection with FIG. 23.

FIG. 34 is a cross-sectional view showing the connector in the fitting completion state with the counter connector in connection with FIG. 20.

FIG. 35 is a cross-sectional view showing the connector in the fitting completion state with the counter connector in connection with FIG. 21.

FIG. 36 is an enlarged partial view of FIG. 35.

FIG. 37 is a cross-sectional view showing the connector in the fitting completion state with the counter connector in connection with FIG. 23.

FIG. 38 is a cross-sectional view showing a connector according to a modification.

FIG. 39 is an exploded view of a conventional connector.

FIG. 40 is a cross-sectional view showing the conventional connector.

### DETAILED DESCRIPTION OF THE INVENTION

An embodiment of the invention is described below based on the accompanying drawings.

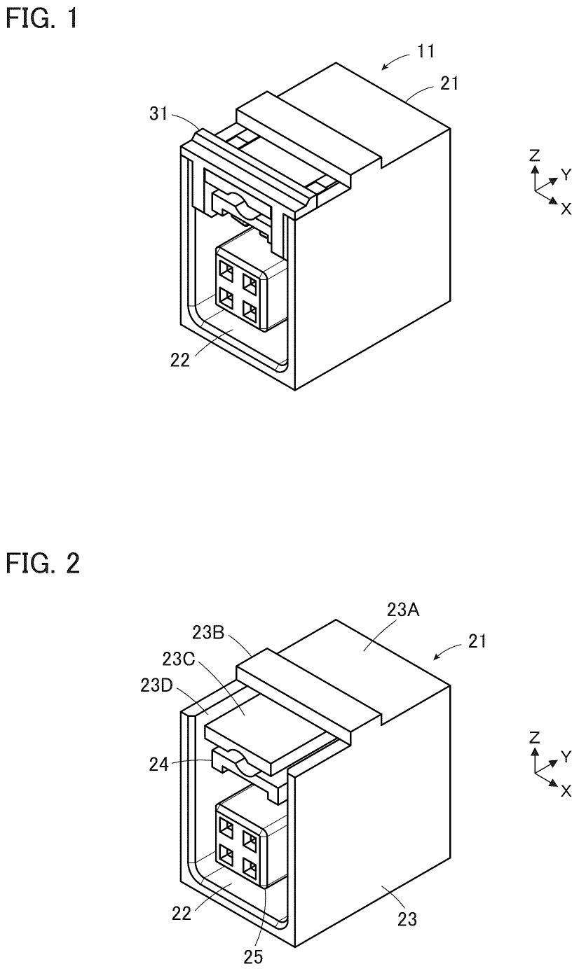

FIG. 1 shows a connector 11 according to the embodiment. The connector 11 includes a housing 21 and a slider 31 incorporated in the housing 21. The housing 21 has a counter connector accommodating portion 22 of recess shape opening in a predetermined direction, and in FIG. 1, the slider 31 is disposed on the upper portion of the housing 21 and incorporated in the housing 21 so as to be slidable along the predetermined direction.

For convenience, the predetermined direction in which the slider 31 can slide is defined as “Y direction,” the direction which is orthogonal to the Y direction and in which the slider 31 is disposed with respect to the housing 31 as “+Z direction” (second direction), and the width direction of the housing 21 orthogonal to the Y direction and the Z direction as “X direction” (first direction).

The Y direction represents a fitting direction of the connector 11.

FIG. 2 shows the housing 21. The housing 21 is made of an insulating material and has a housing body 23 which is provided with the counter connector accommodating portion 22 opening in the −Y direction. In addition, the housing 21 has a lock arm 24 and a terminal holding portion 25 each extending in the Y direction and exposed to the counter connector accommodating portion 22. The lock arm 24 and the terminal holding portion 25 are integrally formed with the housing body 23.

On an outer surface 23A of the housing body 23 on the +Z direction side thereof, a protective projection 23B is formed to extend in the X direction and project in the +Z direction.

In addition, the housing body 23 has a flat plate portion 23C of tongue shape extending in the −Y direction along an XY plane from the −Y direction side of the protective projection 23B. A pair of groove portions 23D are each formed between one end portion in the X direction of the flat plate portion 23C and the corresponding side portion in the X direction of the housing body 23 to extend in the Y direction and allow the counter connector accommodating portion 22 and the space above the housing body 23 to communicate with each other.

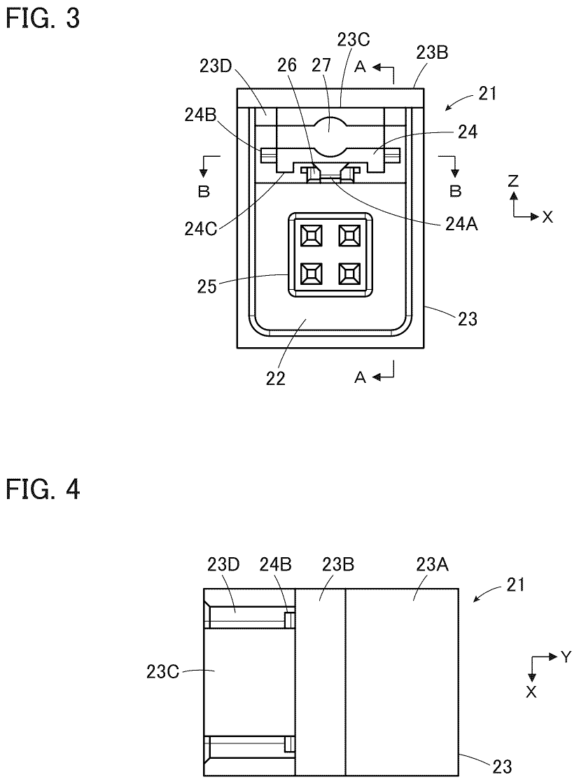

As shown in FIG. 3, the lock arm 24 has a flat plate shape which extends in the −Y direction along an XY plane from the +Y directional end portion of the housing body 23 so as to face the flat plate portion 23C on the −Z direction side of the flat plate portion 23C and is formed so as to be elastically deformable in the Z direction.

A locking portion 24A projecting in the −Z direction is formed on the central portion in the width direction of the lock arm 24, and a cam projection 24B projecting in the X direction is formed on each of the opposite end portions in the width direction of the lock arm 24. Further, a first wall portion 24C is formed to project in the −Z direction from each of the opposite end portions in the width direction of the lock arm 24.

In addition, the housing body 23 has a pair of slide arm deforming portions 26 extending in the Y direction on the −Z direction side of the lock arm 24.

Further, a spring accommodating portion 27 extending in the Y direction is formed on the central portion in the X direction of the housing body 23 and at a position between the flat plate portion 23C and the lock arm 24 and adjacent to the lock arm 24 on the +Z direction side thereof.

As shown in FIG. 4, at a position visible from the +Z direction through the groove portion 23D of the housing body 23, the cam projection 24B of the lock arm 24 is disposed so as to form a slight gap between the cam projection 24B and each of the opposite side portions in the X direction of the housing body 23.

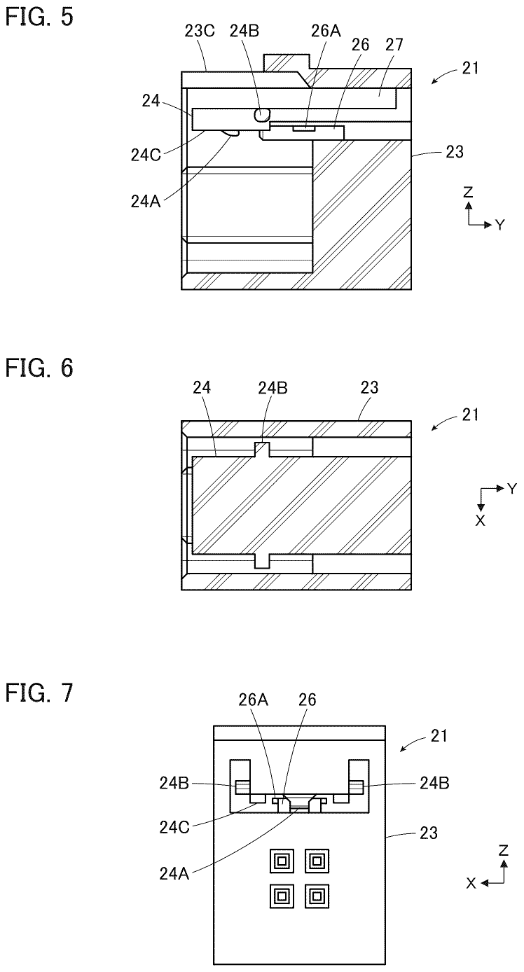

Further, as shown in FIGS. 5 and 6, the cam projection 24B of the lock arm 24 is disposed at an intermediate portion in the Y direction of the lock arm 24, and the first wall portion 24C extends in the Y direction from the −Y directional end portion of the lock arm 24 to the intermediate portion of the lock arm 24 at which the cam projection 24B is disposed.

In addition, the pair of slide arm deforming portions 26 are disposed at an intermediate portion in the Y direction of the housing body 23, and a second wall portion 26A is formed at an intermediate portion in the Y direction of each slide arm deforming portion 26. As shown in FIG. 7, the second wall portion 26A projects in the X direction from each of the pair of slide arm deforming portions 26.

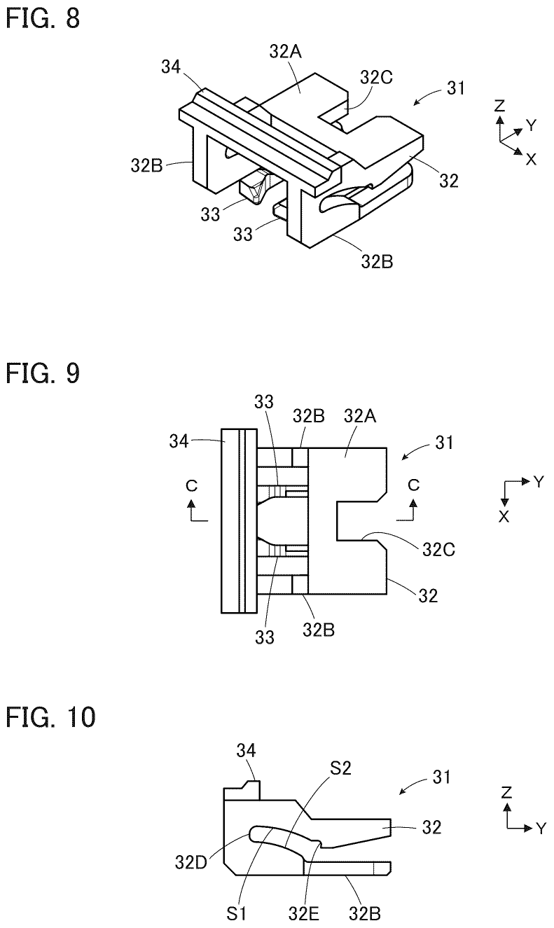

FIG. 8 shows the slider 31. The slider 31 is made of an insulating material and includes a slider body 32. The slider body 32 includes a flat plate portion 32A extending along an XY plane and a pair of side wall portions 32B extending along a YZ plane separately from the opposite ends, in the X direction, of the flat plate portion 32A.

In addition, the slider 31 includes a pair of slide arms 33 separately joined to the −Z directional end portions of the pair of side wall portions 32B of the slide arm 32, and further includes an operating portion 34 which joins the −Y directional end portions and the +Z directional end portions of the pair of side wall portions 32B of the slider body 32 in the X direction.

As shown in FIG. 9, the flat plate portion 32A is provided with a spring insertion portion 32C of recess shape opening in the +Y direction.

As shown in FIG. 10, each of the pair of side wall portions 32B is provided with a cam groove 32D penetrating the side wall portion 32B in the X direction and extending in the Y direction. The cam groove 32D has a first inner wall surface S1 situated on the +Z direction side and a second inner wall surface S2 situated on the −Z direction side, and these first inner wall surface S1 and second inner wall surface S2 are curved in the same direction such that the first inner surface S1 is recessed toward the −Z direction and that the second inner wall surface S2 protrudes toward the +Z direction.

A recessed portion 32E is formed at the +Y directional end portion of the first inner wall surface S1.

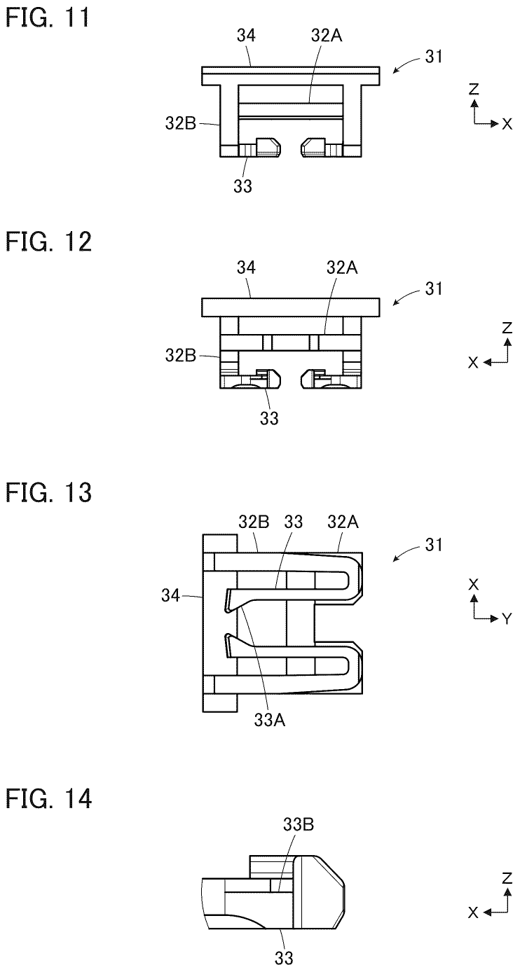

As shown in FIGS. 11 to 13, the pair of slide arms 33 extend in the X direction separately from the −Z directional end portions of the pair of side wall portions 32B so as to approach each other and extend in the −Y direction in parallel to each other, and are formed to be deformable in the X direction.

As shown in FIG. 13, the −Y directional end portions of the pair of slide arms 33 are separately provided with a pair of inclined portions 33A facing each other in the X direction and inclined with respect to the Y direction such that the gap between them becomes wider as advancing in the +Y direction.

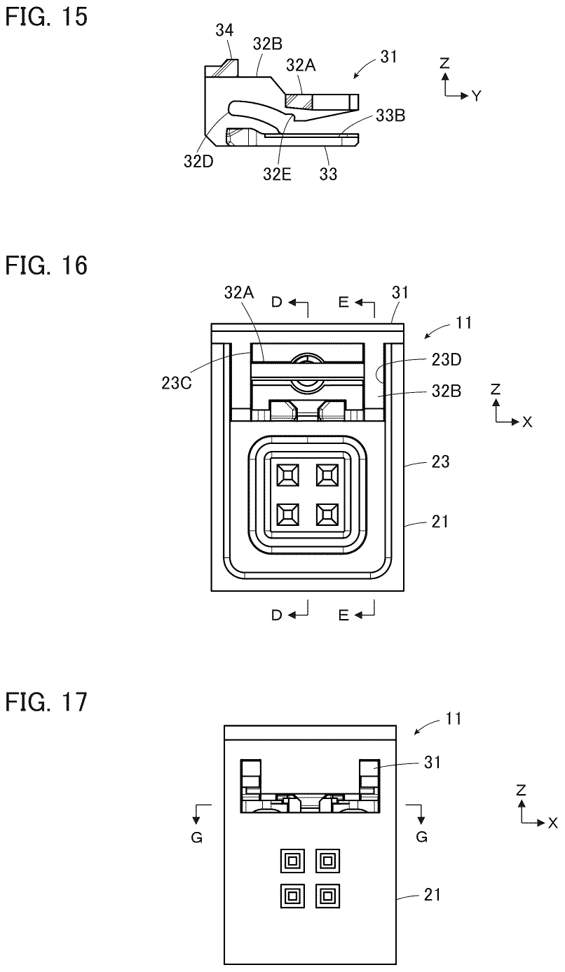

As shown in FIG. 14, a step portion 33B facing in the +Z direction is formed on the +Z directional surface of each slide arm 33. The step portions 33B of the pair of slide arms 33 face each other in the X direction and extend in the Y direction as shown in FIG. 15. The step portions 33B face the second wall portions 26A of the slide arm deforming portions 26 of the housing 21 when the connector 11 is assembled.

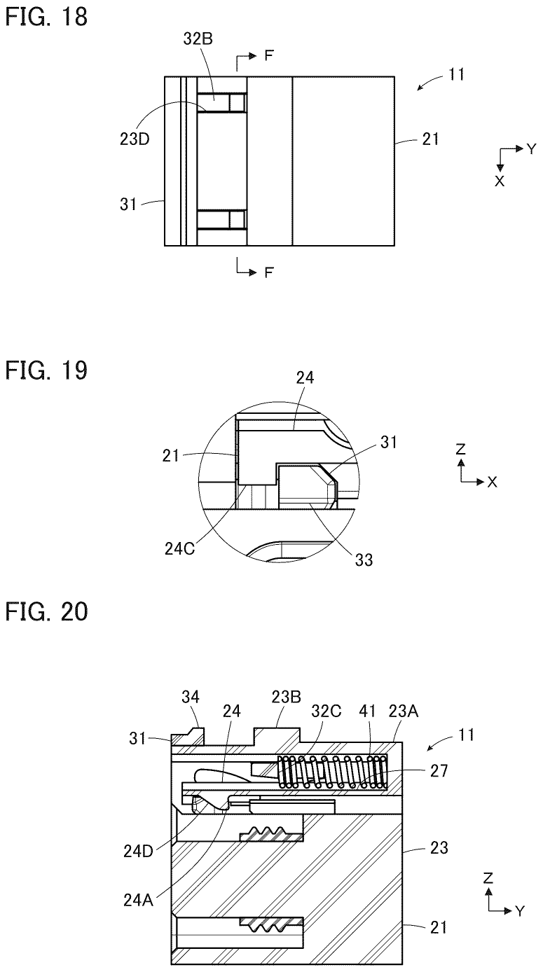

With the slider 31 being incorporated into the housing 21, the connector 11 is formed as shown in FIGS. 16 to 18. When the flat plate portion 32A of the slider 31 is disposed on the −Z directional surface of the flat plate portion 23C of the housing 21 in the state where the pair of side wall portions 32B of the slider 31 are inserted into the pair of groove portions 23D of the housing 21, the slider 31 is disposed on the upper portion of the housing 21. At this time, the opposite end portions in the X direction of the flat plate portion 32A of the slider 31 are situated on the opposite end portions in the X direction of the housing body 23.

As shown in FIG. 19, the first wall portion 24C of the lock arm 24 of the housing 21 is situated on the X direction side of the slide arm 33 of the slider 31 incorporated into the housing 21, whereby the slide arm 33 is prevented from being displaced in the X direction.

As shown in FIG. 20, one compressed coil spring 41 as an elastic member is accommodated in the spring accommodating portion 27 formed to be adjacent to the +Z direction side of the lock arm 24 of the housing 21, the −Y directional end portion of the coil spring 41 is inserted into the spring insertion portion 32C of the flat plate portion 32A of the slider 31, and the slider 31 is pushed in the −Y direction with respect to the housing 21 due to a restoring force of the coil spring 41.

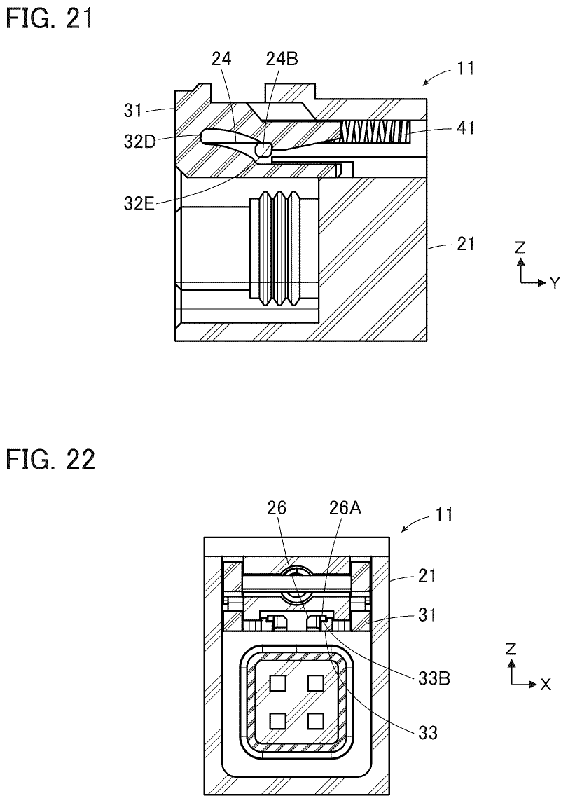

However, as shown in FIG. 21, the cam projection 24B of the lock arm 24 of the housing 21 makes contact with a surface, facing in the −Y direction, of the recessed portion 32E formed in the cam groove 32D of the slider 31, whereby the slider 31 does not move in the −Y direction, and the position thereof shown in FIG. 21 is maintained. This position of the slider 31 with respect to the housing 21 is called “initial position.”

When the slider 31 is situated at the initial position with respect to the housing 21, the operating portion 34 of the slider 31 is disposed at the position corresponding to the front end portion of the housing 21 in the Y direction, i.e., the −Y directional end portion of the housing 21.

In addition, the cam projection 24B of the lock arm 24 of the housing 21 makes contact also with a surface, facing in the −Z direction, of the recessed portion 32E formed in the cam groove 32D of the slider 31, and thus, even when a certain force acting in the +Z direction is applied to the −Y directional end portion of the lock arm 24 for example, the lock arm 24 is prevented from being displaced in the +Z direction.

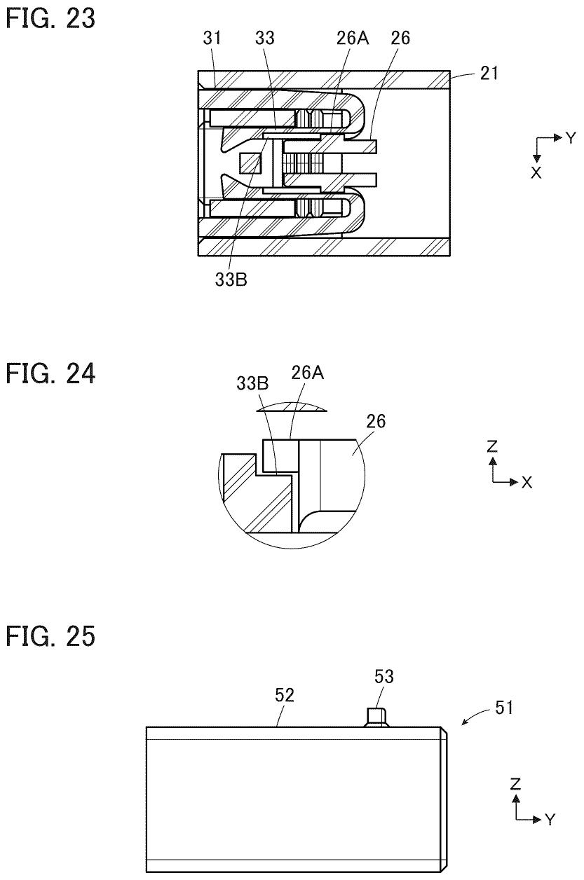

Further, at this time, as shown in FIGS. 22 to 24, the second wall portions 26A of the pair of slide arm deforming portions 26 of the housing 21 are closer to and face the +Z direction side with respect to the step portions 33B of the pair of slide arms 33 of the slider 31, and thus, the slide arm 33 is prevented from being displaced in the +Z direction.

In addition, as shown in FIG. 20, the locking portion 24A projecting in the −Z direction from the lock arm 24 includes a tapered portion 24D inclined with respect to the Y direction and facing both in the −Y direction and the −Z direction.

While the operating portion 34 of the slider 31 is situated on the −Y direction side from the protective projection 23B of the housing 21 and projects in the +Z direction from the outer surface 23A on the +Z direction side of the housing body 23, the protective projection 23B has a projection height larger than the projection height of the operating portion 34 from the outer surface 23A.

It should be noted that in the connector 11, a pair of cam projections 24B formed to project at the opposite end portions in the X direction of the lock arm 24 of the housing 21 are inserted into the cam grooves 32D of the pair of side wall portions 32B of the slider 31, the pair of slide arms 33 of the slider 31 are disposed on the −Z direction side from the lock arm 24, and the pair of slide arms 33 make contact with the counter locking portion 53 of the counter connector 51, whereby the slider 31 is retracted in the +Y direction.

Therefore, the slider 31 can be disposed in the housing 21 without being exposed on the +Z direction side of the housing 21 and the rear side of the housing 21, i.e., on the +Y direction side of the housing 21. Specifically, in the case where the slider 31 is situated at the initial position with respect to the housing 21, the operating portion 34 of the slider 31 can be disposed at the position corresponding to the front end portion of the housing 21 in the Y direction, i.e., the −Y directional end portion of the housing 21. As a result, when the connector 11 is fitted with the counter connector 51, the operator can grasp the connector 11 without touching the slider 31, and thus the operability can be improved.

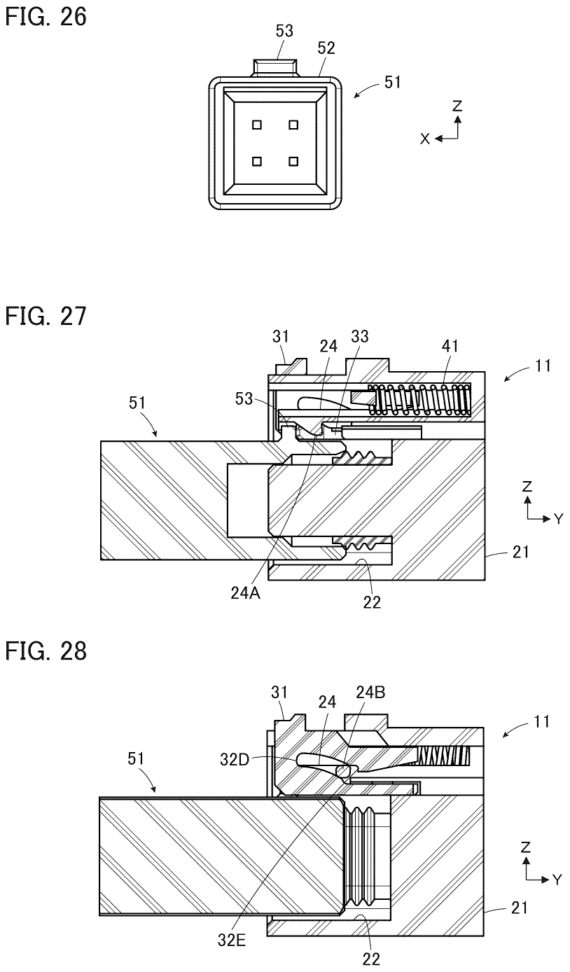

FIGS. 25 and 26 show the counter connector 51 which is fitted with the connector 11 and forms, together with the connector 11, a connector assembly. The counter connector 51 includes a counter housing 52 and a counter locking portion 53 projecting in the +Z direction from the +Z directional surface of the counter housing 52. A plurality of counter terminals not shown are held inside the counter housing 52.

The fitting operation of the connector assembly composed of the connector 11 and the counter connector 51 that have such configurations will be described.

As shown in FIG. 27, first, when the counter connector 51 is relatively inserted into the counter connector accommodating portion 22 of the housing 21 of the connector 11, the counter locking portion 53 of the counter connector 51 abuts the front end portions, i.e., the −Y directional end portions of the pair of slide arms 33 of the slider 31, and the slider 31 starts to be retracted in the +Y direction from the initial position against an elastic force of the coil spring 41.

At this time, as shown in FIG. 28, the cam projection 24B of the lock arm 24 is moved away from the recessed portion 32E of the slider 31 and starts to enter the cam groove 32D.

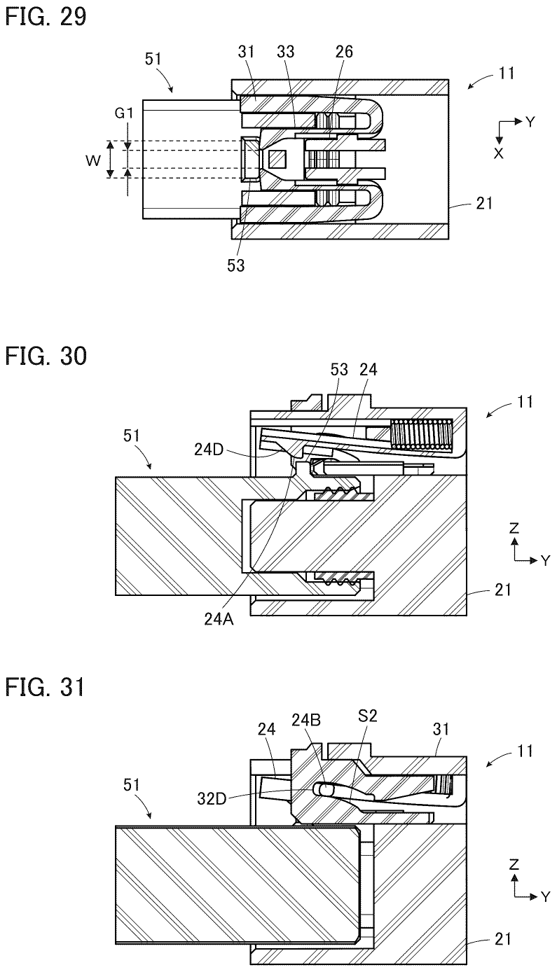

In addition, as shown in FIG. 29, the pair of slide arms 33 of the slider 31 still do not make contact with the pair of slide arm deforming portions 26 of the housing 21 and thus are not elastically deformed in the X direction. Therefore, the gap G1 in the X direction between the front end portions of the pair of slide arms 33 is smaller than the width W in the X direction of the counter locking portion 53 of the counter connector 51, and the state where the slider 31 is retracted in the +Y direction is maintained due to the counter connector 51.

Further, when the insertion of the counter connector 51 into the counter connector accommodating portion 22 of the connector 11 advances, the counter locking portion 53 of the counter connector 51 makes contact with the tapered portion 24D formed at the locking portion 24A of the lock arm 24 and pulls the −Y directional end portion of the lock arm 24 up in the +Z direction. Thus, as shown in FIG. 30, the lock arm 24 is elastically deformed in the Z direction, and the locking portion 24A runs over the +Z direction side of the counter locking portion 53 of the counter connector 51.

At this time, as shown in FIG. 31, the cam projection 24B of the lock arm 24 is inserted into the cam groove 32D of the slider 31 and makes contact with the second inner wall surface S2 of the cam groove 32D, whereby the state where the lock arm 24 is elastically deformed is maintained.

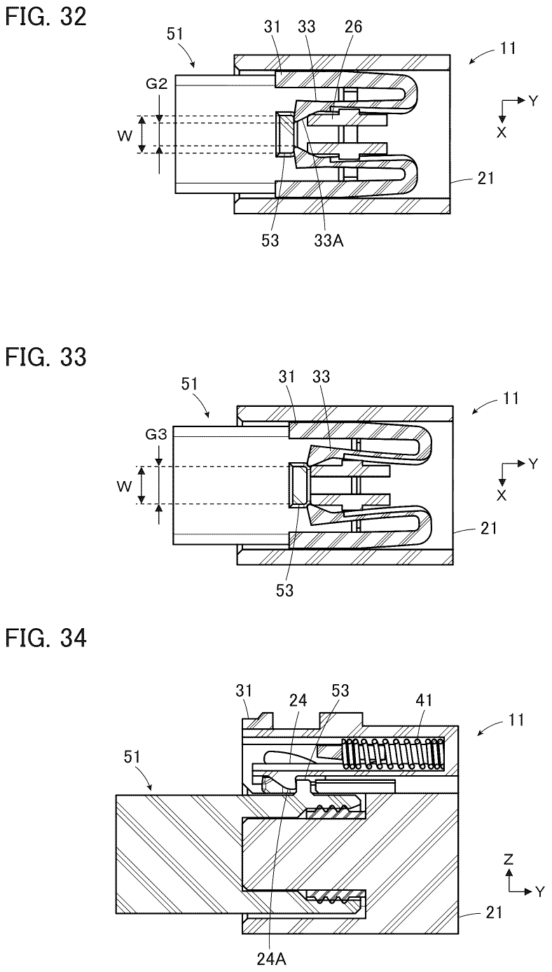

As shown in FIG. 32, the inclined portions 33A of the pair of slide arms 33 of the slider 31 start to make contact with the pair of slide arm deforming portions 26 of the housing 21. Thus, the pair of slide arms 33 are pushed by the pair of slide arm deforming portions 26 and elastically deformed in the X direction, and a gap G2 in the X direction between the front end portions of the pair of slide arms 33 starts to increase. However, the gap G2 is still smaller than the width W in the X direction of the counter locking portion 53 of the counter connector 51, so the slider 31 continues to be retracted in the +Y direction due to the counter connector 51.

Elastic deformation of the pair of slide arms 33 gradually increases according to relative insertion of the counter connector 51 into the counter connector accommodating portion 22 of the connector 11, and as shown in FIG. 33, when the gap G3 in the X direction between the front end portions of the pair of slide arms 33 becomes equal to the width W in the X direction of the counter locking portion 53 of the counter connector 51, the contact between the pair of slide arms 33 and the counter locking portion 53 is released.

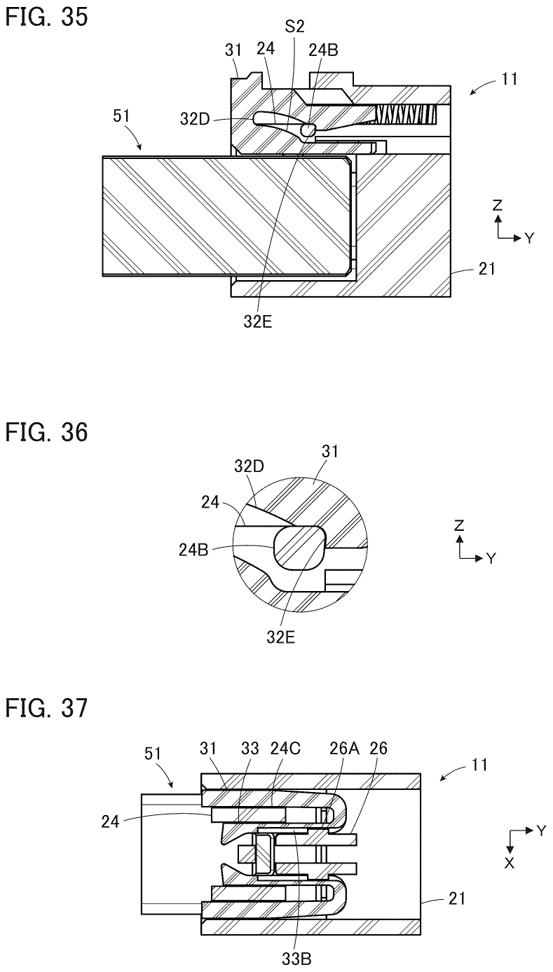

When the contact between the pair of slide arms 33 and the counter locking portion 53 is released, the slider 31 is no longer restrained by the counter connector 51, receives the restoring force of the compressed coil spring 41 to move in the −Y direction with respect to the housing 21, and returns to the initial position as shown in FIGS. 34 and 35.

With the slider 31 moving in the −Y direction, the cam projection 24B of the lock arm 24 is moved away from the second inner wall surface S2 of the cam groove 32D of the slider 31 and makes contact with the recessed portion 32E of the cam groove 32D.

Thus, the lock arm 24 elastically deformed in the Z direction is elastically restored and returned to a flat plate state, and the locking portion 24A of the lock arm 24 lowers in the −Z direction and thus is situated on the −Y direction side of the counter locking portion 53 of the counter connector 51.

Accordingly, the connector 11 is fitted to the counter connector 51 to form a connector assembly, and the locking portion 24A of the lock arm 24 is situated on the −Y direction side of the counter locking portion 53 of the counter connector 51, whereby the fitting state of the connector assembly is locked.

At this time, as shown in FIG. 36, the cam projection 24B of the lock arm 24 makes contact with a surface, facing in the −Y direction, of the recessed portion 32E of the slider 31, whereby the slider 31 is maintained at the initial position while receiving the elastic force in the −Y direction from the coil spring 41, and the cam projection 24B of the lock arm 24 makes contact with the surface, facing in the −Z direction, of the recessed portion 32E of the slider 31, whereby the lock arm 24 is prevented from being displaced in the +Z direction.

Further, as shown in FIG. 37, when the pair of first wall portions 24C of the lock arm 24 of the housing 21 are situated on the opposite sides in the X direction of the pair of slide arms 33 of the slider 31, the pair of slide arms 33 are prevented from being displaced so as to be widened in the X direction, and further, the second wall portion 26A of the pair of slide arm deforming portions 26 of the housing 21 are situated on the +Z direction side of the step portions 33B of the pair of slide arms 33 of the slider 31, whereby the pair of slide arms 33 are prevented from being displaced in the +Z direction.

In addition, since the pair of first wall portions 24C of the lock arm 24 project in the −Z direction separately from the opposite side portions in the width direction of the lock arm 24 and extend in the Y direction from the −Y directional end portion of the lock arm 24 to the intermediate portion of the lock arm 24 at which the cam projection 24B is disposed, part of the lock arm 24 extending from the cam projection 24B to the −Y directional end portion is reinforced with the pair of first wall portions 24C, and the fitting state between the connector 11 and the counter connector 51 can be firmly locked.

Thus, with the connector 11 according to the embodiment, only by relatively inserting the counter connector 51 into the counter connector accommodating portion 22, the slider 31 is retracted in the +Y direction, and the connector 11 and the counter connector 51 are automatically and surely fitted with each other to form a connector assembly. Further, the fitting state is locked.

It should be noted that to release the fitting state of the connector assembly composed of the connector 11 and the counter connector 51, it suffices if a finger is put on the operating portion 34 of the slider 31, and the slider 31 is retracted in the +Y direction with respect to the housing 21 against the elastic force of the coil spring 41. Thus, the cam projection 24B of the lock arm 24 is relatively moved in the −Y direction along the cam groove 32D while making contact with the second inner wall surface S2 of the cam groove 32D of the slider 31, whereby the lock arm 24 is elastically deformed in the +Z direction. As a result, the locking portion 24A of the lock arm 24 is lifted up to the +Z direction side of the counter locking portion 53 of the counter connector 51, and the locking of the fitting state between the connector 11 and the counter connector 51 is released.

In this state, when the counter connector 51 is relatively pulled out in the −Y direction from the counter connector accommodating portion 22 of the connector 11, the fitting state of the connector assembly composed of the connector 11 and the counter connector 51 is released.

As shown in FIG. 20, the protective projection 23B of the housing 21 is disposed on the +Y direction side of the operating portion 34 of the slider 31 and has a projection height higher than the projection height of the operating portion 34 from the outer surface 23A of the housing body 23 on the +Z direction side. Due to the presence of the protective projection 23B as above, the slider 31 is prevented from being mistakenly touched by an operator when the connector 11 and the counter connector 51 are fitted with each other.

In addition, while one coil spring 41 is accommodated in the spring accommodating portion 27 of the housing body 23 as shown in FIG. 20, during the fitting operation of the connector 11, the coil spring 41 is compressed in the +Y direction, as shown in, for example, FIG. 30, along with the retraction of the slider 31 in the +Y direction. Therefore, although the lock arm 24 is elastically deformed in the +Z direction along with the retraction of the slider 31, as shown in FIG. 3, in the central portion in the X direction of the housing body 23, the spring accommodating portion 27 extending in the Y direction can be formed at the position between the flat plate portion 23C and the lock arm 24 and adjacent to the lock arm 24 on the +Z direction side thereof.

As a result, as in the connector of JP 6265383 B2 shown in FIG. 39, it is not necessary to dispose a pair of coil springs on the opposite sides in the X direction of the housing 21, and only when one coil spring 41 is disposed in the central portion in the X direction of the housing 21, the fitting of the connector 11 to the counter connector 51 and the locking of the fitting can be performed.

Therefore, the number of components and the manufacturing cost of the connector 11 can be reduced.

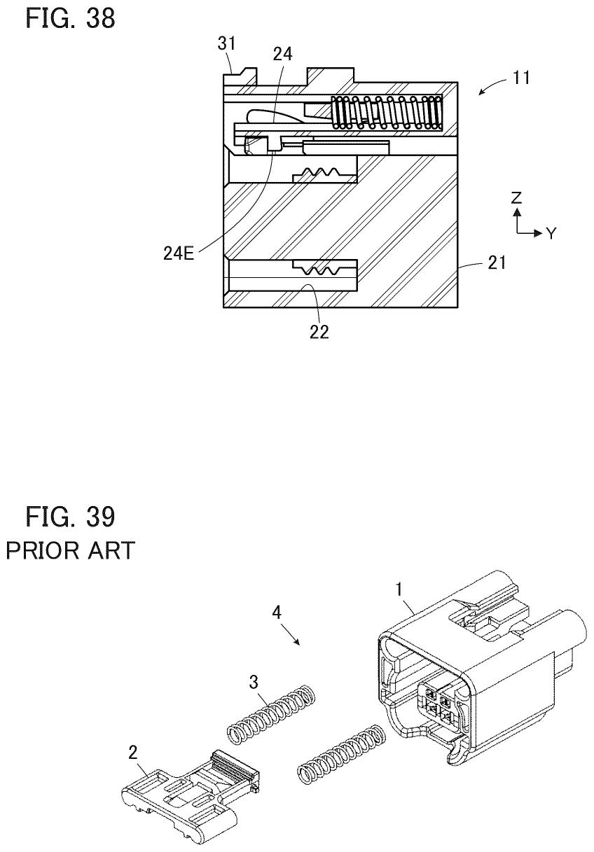

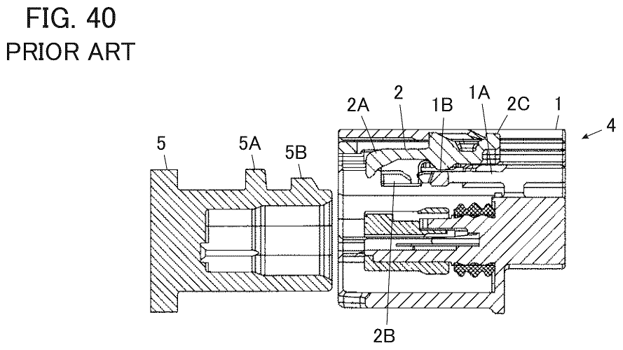

In the embodiment as above, the locking portion 24A of the lock arm 24 includes the tapered portion 24D, but the invention is not limited thereto, and for example, as shown in FIG. 38, the lock arm 24 may include a locking portion 24E having no tapered portion.

When the counter connector 51 is relatively inserted into the counter connector accommodating portion 22 of the housing 21 of the connector 11 so that the slider 31 is retracted in the +Y direction from the initial position, the cam projection 24B of the lock arm 24 is inserted into the cam groove 32D of the slider 31 and makes contact with the second inner wall surface S2 of the cam groove 32D, whereby the lock arm 24 is elastically deformed gradually in the +Z direction, and as in FIGS. 30 and 31 in the above embodiment, the lock portion 24A runs over the +Z direction side of the counter locking portion 53 of the counter connector 51.

Thereafter, when the pair of slide arms 33 of the slider 31 are elastically deformed so that the contact between the pair of slide arms 33 and the counter locking portion 53 is released, as in FIGS. 34 and 35 in the above embodiment, the slider 31 is returned to the initial position due to the restoring force of the coil spring 41, and the lock arm 24 is elastically restored so that the connector 11 is fitted to the counter connector 51.

Further, the locking portion 24E of the lock arm 24 shown in FIG. 38 is situated on the −Y direction side of the counter locking portion 53 of the counter connector 51, whereby the fitting state between the connector 11 and the counter connector 51 is locked.

In addition, to release the fitting state between the connector 11 and the counter connector 51, it suffices if the slider 31 is retracted in the +Y direction with respect to the housing 21.

Thus, even when the lock arm 24 includes the locking portion 24E having no tapered portion, as with the embodiment above, a series of operations, i.e., fitting between the connector 11 and the counter connector 51, locking of the fitting state, releasing of locking of the fitting state, and releasing of the fitting state can be performed.

What is claimed is:

1. A connector comprising:
a housing having a counter connector accommodating portion;
a slider disposed on the housing so as to be slidable along a fitting direction; and
an elastic member for pushing the slider forward along the fitting direction,
wherein the slider includes:
a slider body in which a cam groove extending in the fitting direction is formed;
a slide arm which extends in the fitting direction and is elastically deformable in a first direction orthogonal to the fitting direction; and
an operating portion that is disposed on the slider body and exposed from the housing to project in a second direction orthogonal to both the fitting direction and the first direction,
the housing includes:
a lock arm which extends along the fitting direction, is exposed to the counter connector accommodating portion, and is elastically deformable in the second direction;
a cam projection which is formed to project in the first direction from a side surface of the lock arm and is inserted into the cam groove; and
a slide arm deforming portion which makes contact with the slide arm of the slider retracted in the fitting direction so that the slide arm is elastically deformed in the first direction,
when a counter connector is inserted into the counter connector accommodating portion, the counter connector abuts a front end portion of the slide arm to make the slider retracted from an initial position along the fitting direction,
the lock arm is elastically deformed in the second direction along with insertion of the counter connector into the counter connector accommodating portion,
when the slide arm makes contact with the slide arm deforming portion and is elastically deformed in the first direction, a contact between the slide arm and the counter connector is released, and the slider is returned to the initial position due to the elastic member,
the lock arm is elastically restored so that a fitting state of the connector with the counter connector is locked by a locking portion formed in the lock arm, and
when the slider is retracted from the initial position along the fitting direction by the operating portion, the cam projection is relatively moved along the cam groove so that the lock arm is elastically deformed in the second direction, and a locking of the fitting state of the connector with the counter connector is released.

2. The connector according to claim 1,
wherein the cam groove has a first inner wall surface situated on a side where the operating portion is disposed in the second direction, and a second inner wall surface situated on an opposite side from the operating portion, and
the first inner wall surface and the second inner wall surface are curved in a same direction.

3. The connector according to claim 2, wherein the first inner wall surface has a recessed portion which makes contact with the cam projection both in the fitting direction and the second direction when the slider is situated at the initial position.

4. The connector according to claim 1,
wherein the locking portion has a tapered portion disposed so as to face the counter connector accommodating portion, and
when the counter connector is inserted into the counter connector accommodating portion, the counter connector makes contact with the tapered portion to push the locking portion up in the second direction, whereby the lock arm is elastically deformed.

5. The connector according to claim 2, wherein when the counter connector is inserted into the counter connector accommodating portion and the slider is retracted along the fitting direction, the second inner wall surface of the cam groove makes contact with the cam projection, whereby the lock arm is elastically deformed.

6. The connector according to claim 1, wherein part of the lock arm which is exposed to the counter connector accommodating portion has a first wall portion projecting in the second direction for preventing the slide arm that is not in contact with the slide arm deforming portion from being displaced in the first direction.

7. The connector according to claim 1, wherein the slide arm deforming portion includes a second wall portion preventing the slide arm from being displaced in the second direction.

8. The connector according to claim 1, wherein the operating portion is disposed at a position corresponding to a front end portion of the housing in the fitting direction when the slider is situated at the initial position.

9. The connector according to claim 1,
wherein the operating portion projects in the second direction from a predetermined outer surface of the housing facing in the second direction,
the housing includes a protective projection projecting in the second direction from the predetermined outer surface, and
the protective projection has a projection height not smaller than a projection height of the operating portion from the predetermined outer surface.

10. The connector according to claim 1,
wherein the slider body has a pair of the cam grooves disposed on opposite sides of the lock arm in the first direction and facing each other in the first direction,
the housing has a pair of the cam projections formed on opposite side surfaces in the first direction of the lock arm and projecting therefrom, and
the pair of the cam projections are separately inserted into the pair of the cam grooves.

11. The connector according to claim 1,
wherein the slider has a pair of the slide arms facing each other in the first direction, and
when the slider is retracted in the fitting direction from the initial position, the pair of the slide arms are elastically deformed so as to be separated from each other in the first direction due to the slide arm deforming portion.

12. The connector according to claim 1,
wherein the elastic member comprises one coil spring, and
the housing has a spring accommodating portion adjacent to the lock arm on the second direction side.
